(19) United States
(12) Patent Application Publication
(10) Pub. No.: US 2012/0102462 A1
(43) Pub. Date: Apr. 26, 2012

(54) PARALLEL TEST EXECUTION

(75) Inventors: Colin J. W. Kushneryk, Renton, WA (US); Paul D. Barnett, Renton, WA (US)

(73) Assignee: Microsoft Corporation, Redmond, WA (US)

(21) Appl. No.: 12/911,739

(22) Filed: Oct. 26, 2010

(51) Int. Cl. G06F 9/44

(52) U.S. Cl. 717/124

(57) ABSTRACT

Aspects of the subject matter described herein relate to test execution. In aspects, a collection is obtained of tests that are configured to be executed in a primary test environment. One or more of the tests are then executed in an auxiliary test environment in parallel with executing one or more of the tests in the primary test environment. Before executing a test in the primary test environment, a check is performed to determine whether the test has already been executed in the auxiliary test environment. If it has, the test is not executed in the primary test environment and results are obtained and incorporated into the primary test environment to make it appear as if the test executed in the primary test environment.

### BACKGROUND

A software tool may allow a developer to run tests on developed code. The tool may allow the developer to specify multiple tests to run and may then run the tests sequentially until all the tests have been run. Unfortunately, running tests sequentially may take a long time.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Briefly, aspects of the subject matter described herein relate to test execution. In aspects, a collection is obtained of tests that are configured to be executed in a primary test environment. One or more of the tests are then executed in an auxiliary test environment in parallel with executing one or more of the tests in the primary test environment. Before executing a test in the primary test environment, a check is performed to determine whether the test has already been executed in the auxiliary test environment. If it has, the test is not executed in the primary test environment and results are obtained and incorporated into the primary test environment to make it appear as if the test executed in the primary test environment.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” is to be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram that includes primary and auxiliary test environments in accordance with aspects of the subject matter described herein;

FIG. 3 is an exemplary user interface that may be used to display status of tests in the auxiliary test environment in accordance with aspects of the subject matter described herein; and

FIGS. 4-5 are flow diagrams that generally represent exemplary actions that may occur in accordance with aspects of the subject matter described herein.

### DETAILED DESCRIPTION

### Definitions

As used herein, the term “includes” and its variants are to be read as open-ended terms that mean “includes, but is not limited to.” The term “or” is to be read as “and/or” unless the context clearly dictates otherwise. The term “based on” is to be read as “based at least in part on.” The terms “one embodiment” and “an embodiment” are to be read as “at least one embodiment.” The term “another embodiment” is to be read as “at least one other embodiment.”

As used herein, terms such as “a,” “an,” and “the” are inclusive of one or more of the indicated item or action. In particular, in the claims a reference to an item generally means at least one such item is present and a reference to an action means at least one instance of the action is performed.

Headings are for convenience only; information on a given topic may be found outside the section whose heading indicates that topic.

Other definitions, explicit and implicit, may be included below.

### Exemplary Operating Environment

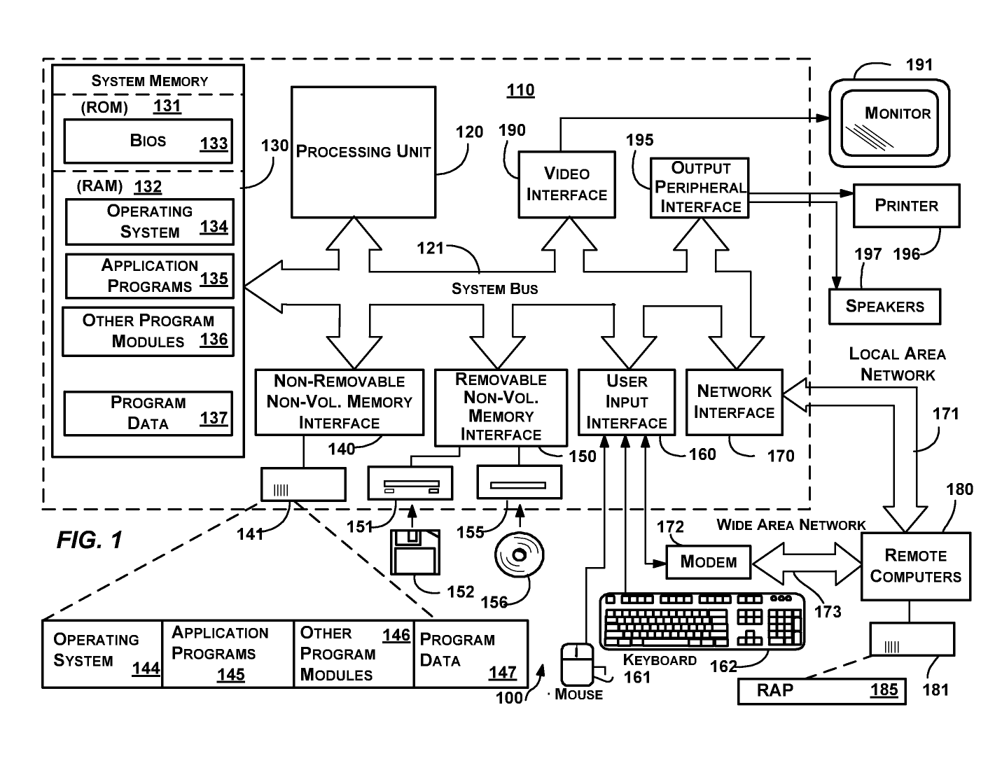

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well-known computing systems, environments, or configurations that may be suitable for use with aspects of the subject matter described herein comprise personal computers, server computers, hand-held or laptop devices, multiprocessor systems, microcontroller-based systems, set-top boxes, programmable consumer electronics, network PCs, minicomputers, mainframe computers, personal digital assistants (PDAs), gaming devices, printers, appliances including set-top, media center, or other appliances, automobile-embedded or attached computing devices, other mobile devices, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. A computer may include any electronic device that is capable of executing an instruction. Components of the computer 110 may include a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, Peripheral Component Interconnect Extended (PCI-X) bus, Advanced Graphics Port (AGP), and PCI express (PCIe).

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules, or other data. Computer storage media includes RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include magnetic tape cassettes, flash memory cards, digital versatile discs, other optical discs, digital video tape, solid state RAM, solid state ROM, and the like. The hard disk drive 141 may be connected to the system bus 121 through the interface 140, and magnetic disk drive 151 and optical disc drive 155 may be connected to the system bus 121 by an interface for removable non-volatile memory such as the interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies.

A user may enter commands and information into the computer 110 through input devices such as a keyboard 162 and pointing device 161, commonly referred to as a mouse, trackball, or touch pad. Other input devices (not shown) may include a microphone, joystick, game pad, satellite dish, scanner, a touch-sensitive screen, a writing tablet, or the like. These and other input devices are often connected to the processing unit 120 through a user input interface 160 that is coupled to the system bus, but may be connected by other interface and bus structures, such as a parallel port, game port or a universal serial bus (USB).

A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 may include a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Testing Software

As mentioned previously, a software tool that runs tests sequentially may take a long time to execute. Even software tools that run tests in parallel may be constrained.

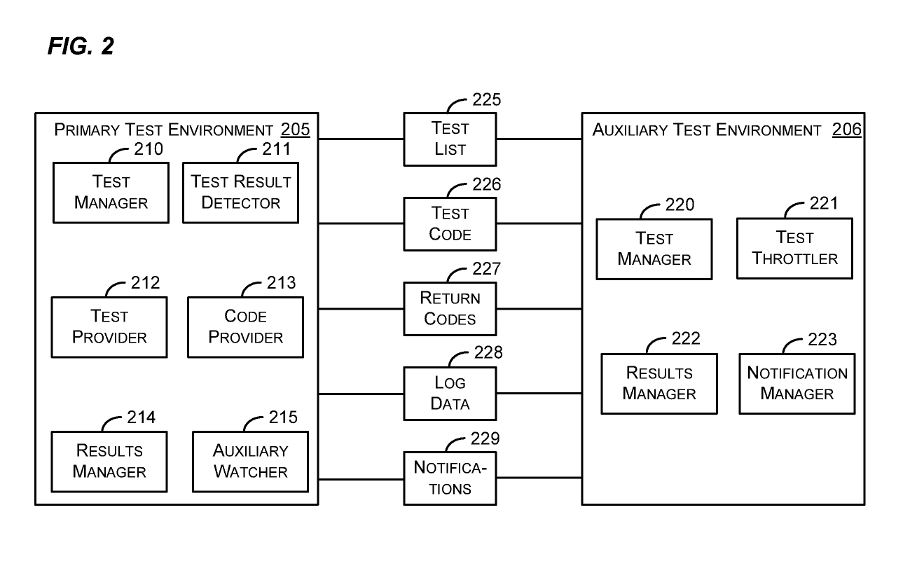

FIG. 2 is a block diagram that includes primary and auxiliary test environments in accordance with aspects of the subject matter described herein. The entities illustrated in FIG. 2 are exemplary and are not meant to be all-inclusive of components that may be needed or included in an implementation. In other embodiments, one or more of the entities described in conjunction with FIG. 2 may be included in other entities (shown or not shown) or divided into other entities without departing from the spirit or scope of aspects of the subject matter described herein. In some embodiments, the entities described in conjunction with FIG. 2 may be distributed across multiple devices.

One or more of the entities may be implemented using one or more computers (e.g., the computer 110 of FIG. 1) and storage devices associated therewith. The various entities may be reachable (e.g., communicably coupled) via various networks including intra- and inter-office networks, one or more local area networks, wide area networks, direct connections, virtual connections, private networks, virtual private networks, some combination of the above, and the like.

The primary test environment 205 may include one or more components that assist in testing software code. These components may include, for example, a test manager 210, a test result detector 211, a test provider 212, a code provider 213, a results manager 214, an auxiliary watcher 215, other components (not shown), and the like.

In one embodiment, the primary test environment 205 may part of a development tool. A development tool may be used to develop and/or deploy software. In one exemplary embodiment, the development tool may comprise an integrated development environment (IDE) that allows a software developer to enter and update code, debug code, create and update databases, associate the code with one or more databases, compile the code, create a package, test the code, do other actions, and the like.

The auxiliary test environment 206 may include a test manager 220, a test throttler 221, a results manager 222, a notification manager 223, other components (not shown), and the like.

The primary test environment 205 and the auxiliary test environment 206 may be implemented on the same computer, on two separate computers, on one or more of the same computers, on two or more different computers, and the like. In various configurations, the primary test environment 205 may be implemented on a first set of one or more computers and the auxiliary environment may be implemented on a second set of one or more computers. The first and second sets may or may not have one or more members in common.

One or more of the primary test environment 205 and the auxiliary test environment 206 may be implemented in a virtual environment. A virtual environment is an environment that is simulated or emulated by a computer. The virtual environment may simulate or emulate a physical machine, operating system, set of one or more interfaces, portions of the above, combinations of the above, or the like. When a machine is simulated or emulated, the machine is sometimes called a virtual machine. A virtual machine is a machine that, to software executing on the virtual machine, appears to be a physical machine. The software may save files in a virtual storage device such as virtual hard drive, virtual floppy disk, and the like, may read files from a virtual CD, may communicate via a virtual network adapter, and so forth.

More than one virtual environment may be hosted on a single computer. That is, two or more virtual environments may execute on a single physical computer. To software executing in each virtual environment, the virtual environment appears to have its own resources (e.g., hardware) even though the virtual environments hosted on a single computer may physically share one or more physical devices with each other and with the hosting operating system.

When executed, code of the primary test environment 205 may instantiate one or more components of the auxiliary test environment 206. For example, initialization code of the primary test environment 205 may instantiate the test manager 220.

One or more of the components 210-215 and 220-223 may be implemented as a process. The term “process” and its variants as used herein may include one or more traditional processes, threads, components, libraries, objects that perform tasks, and the like. A process may be implemented in hardware, software, or a combination of hardware and software. In an embodiment, a process is any mechanism, however called, capable of or used in performing an action. A process may be distributed over multiple devices or located on a single device.

The data structures 225-229 include data that may be passed between the primary test environment 205 and the auxiliary test environment 206. The data structures 225-229 may be passed in messages, via in-memory data, via files of a file system, or the like. Two or more of the data structures may be combined into a single data structure. A single data structure as illustrated may be separated into multiple data structures.

The test list data structure 225 may include a collection of tests that are configured to be executed in the primary test environment 205. The test code data structure 226 may include code corresponding to the tests. The other data structures 227-229 are described in more detail below.

The test manager 210 may be operable to execute software tests in the primary test environment 205. In particular, the test manager 210 may access a list of tests to execute. For each test of the list, the test manager 210 may execute code of the test, store return codes generated by executing the code, store log data generated by executing the code, and the like.

A test may include or call code (represented by the test result detector 211) that checks to determine whether the test is executing or has already executed in the auxiliary test environment 206. The code may check a flag (e.g., a Boolean or other value) to determine if the test has already executed. If the test has already executed, executing any more of the test may be omitted in the primary test environment 205. In addition, results from the test may be incorporated into the primary test environment 205 as if the test had actually run in the primary test environment 205.

In other words, if exceptions occurred while executing the test in the auxiliary test environment, these exceptions may be thrown in the primary test environment 205. If the test provided a return code while executing in the auxiliary test environment 206, the return codes may be returned to the test manager 210. If the test wrote entries to a log file, these entries may be written to a log file of the primary test environment 205. In other words, from the perspective of the test manager 210, the test manager 210 may not be aware that the results were obtained from the auxiliary test environment 206.

If the test is executing in the auxiliary test environment 206, the test result detector 211 may take various actions including, for example, waiting for the test to complete in the auxiliary test environment 206, allowing the test to continue executing in the primary test environment 205 and ignoring results generated by executing the test in the auxiliary test environment 206, or the like.

If the test has not executed in the auxiliary test environment 206, the test result detector 211 may wait for the test to execute in the auxiliary test environment 206 and then obtain results therefrom, allow the test to execute in the primary test environment 205 and obtain results therefrom, or the like.

The test provider 212 may provide an indication of tests that are planned to be executed in the primary test environment 205. This indication may, for example, take the form of a collection of identifiers of the tests. Identifiers may include, for example, names of the tests, pointers to code of the tests, or the like. This collection may be passed via a file, an in-memory data structure, or the like that is accessible to the auxiliary test environment 206. Once the test manager 220 receives the collection, the test manager 220 may begin executing one or more of the tests in parallel with each other and also in parallel with any tests or other activities that are occurring in the primary test environment 205.

The term “in parallel” as used here indicates that at least one instruction of at least one test executes after the first instruction and before the last instruction of another test or activity.

In some environments, the test provider 212 may have an API that allows access to a collection of tests. In other environments, however, it may be more difficult to obtain the tests that are planned to be executed. For example, some testing environments do not expose an API that allows access to a collection of such tests. In one such environment, the tests may be obtained by registering a new custom test type, adding a single test of the new custom test type, and causing the test to run first (e.g., by manipulating its test list identifier). As the test runs, it may have access to the list of tests that are configured to be executed. The test may write this list to a file, in-memory data structure, or the like. Later, the list may be passed to the test manager 220 of the auxiliary test environment 206.

The code provider 213 may be operable to provide code of the tests to the auxiliary test environment 206. This may be done by sending the code in a message to the test manager 220, writing the code to a file accessible via the test manager 220, or the like. In some implementations, the code may be extracted from an assembly using reflection or some similar mechanism.

The results manager 214 may be operable to obtain results of an already-executed test from a data structure.

This data structure is accessible from both the primary test environment 205 and the auxiliary test environment 206. The data structure may be included in memory, on non-volatile storage such as disk, or some combination of volatile and non-volatile memory. The results may include data structures represented by the return codes data structure 227, the log data structure 228, and the notifications data structure 229.

The results manager 214 may be called by the test result detector 211 to obtain the results. In conjunction with obtaining the results (e.g., from the data structures 227-229), the results manager 214 may incorporate them into the primary test environment 205 using the techniques previously described.

The auxiliary watcher 215 may display a user interface such as a window that allows a user to see the progress of tests in the auxiliary test environment. The auxiliary watcher may obtain notifications from the notifications data structure 229. Instead of posting each event as it occurs to the window, the auxiliary watcher 215 may periodically (e.g., at a configurable interval) post events from the notifications 229 to the window in a batch so as to avoid overwhelming the rendering mechanisms of the window. The window may provide such status as how many tests have started, how many have completed, how many are running, how many have passed, how many have failed, and the like as well as status for each test such as test name, duration of last request, current request, whether the test passed or failed, and the like.

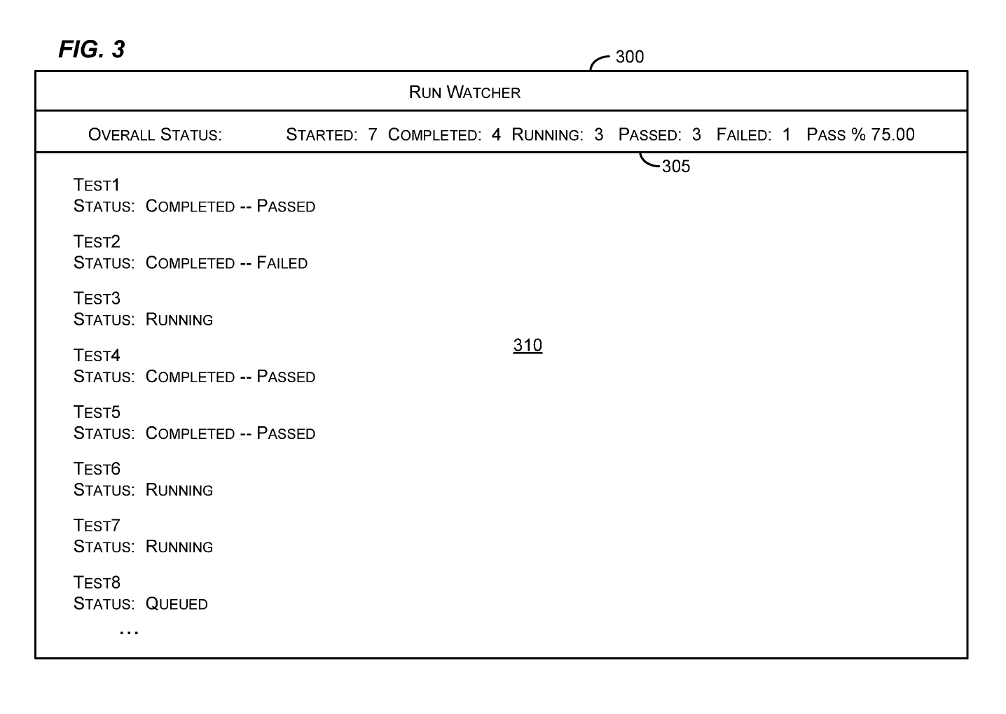

FIG. 3 is an exemplary user interface that may be used to display status of tests in the auxiliary test environment in accordance with aspects of the subject matter described herein. As illustrated a window 300 includes an overall status portion 305 as well as a test status portion 310. The format, spacing, status items, and graphics of FIG. 3 are intended to be exemplary only. Based on the teachings herein, those skilled in the art will recognize other formats, spacing, status items, and graphics that may be used to display status of tests in the auxiliary test environment without departing from the spirit or scope of aspects of the subject matter described herein.

Returning to FIG. 2, as part of the auxiliary test environment 206, the test manager 220 may be in charge of executing tests in the auxiliary test environment 206. The test manager 220 may obtain a collection of tests from the test provider 212, may obtain code for the tests from the code provider 213, and may begin executing the tests in the auxiliary test environment 206. The test manager 220 may execute tests in different processes to increase parallelism. The test manager 220 may consult the test throttler 221 before executing a test.

The test throttler 221 may restrict how many tests are allowed to execute in parallel at any given time in the auxiliary test environment 206 based on a threshold. The threshold may include, for example, a thread threshold, a network threshold, a processor threshold, a number of tests executing in one or more threads, some other threshold, a combination of two or more of the above, and the like. If executing another test would exceed a threshold, the test throttler 221 may not allow the test to be executed until executing the test would not exceed the threshold.

The results manager 222 may be operable to populate a data structure that includes results of executing tests in the auxiliary test environment 206. The data structure may include a return codes data structure 227 and a log data structure 228. The result manager 222 may populate the data structure by obtaining return codes from tests that complete as well as log entries from the tests and placing them in the return codes data structure 227 and the log data structure 228, respectively. Return codes may include exceptions thrown by a test as well as values returned by a test.

The notification manager 223 may generate statuses of tests that are or will be executed in the auxiliary test environment 206. In particular, the notification manager 223 may generate events such as test queued, test executing, test completed, test succeeded, test failed, other events, and the like. Data corresponding to these events may be placed in the notifications data structure 229 for use by the auxiliary watcher 215.

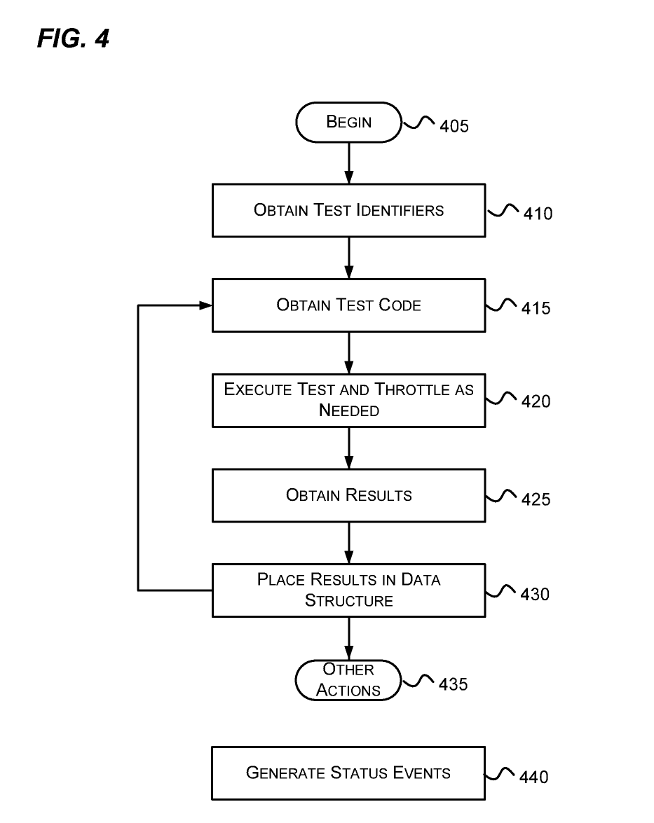

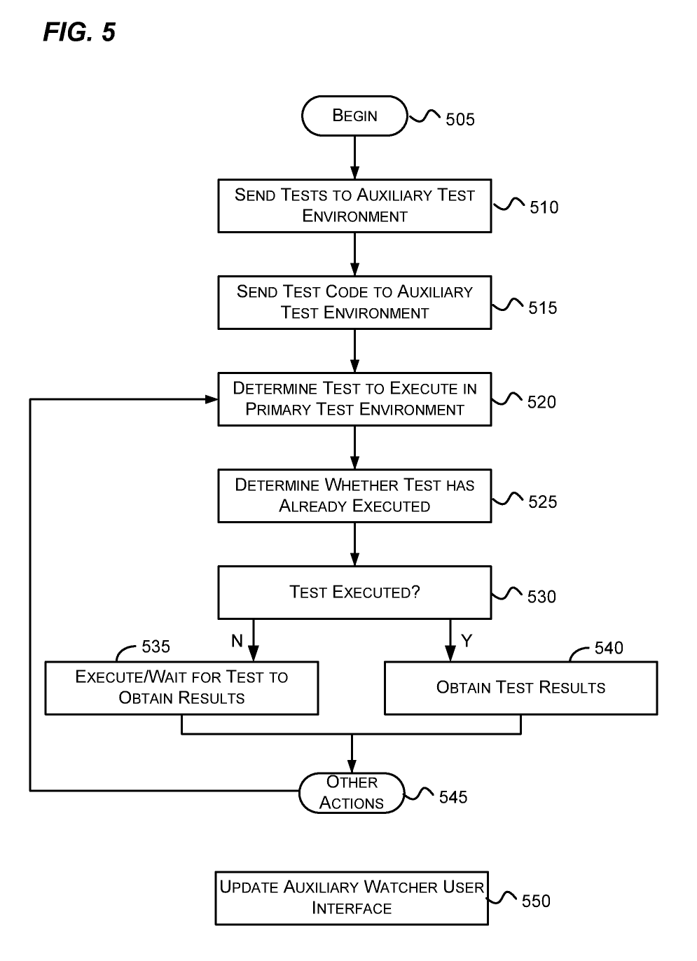

FIGS. 4-5 are flow diagrams that generally represent exemplary actions that may occur in accordance with aspects of the subject matter described herein. For simplicity of explanation, the methodology described in conjunction with FIGS. 4-5 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

Turning to FIG. 4, at block 405, the actions begin.

At block 410, test identifiers are obtained for tests configured to be executed in a test environment. For example, referring to FIG. 2, the test manager 220 may obtain a test list data structure 225 from the test provider 212. Configured to be executed in the test environment means that the test manager 210 is configured to execute the tests. Such configuration may involve indicating (e.g., via user interface) the tests to the test manager 210.

At block 415, the test code for one or more of the tests is obtained. For example, referring to FIG. 2, the test manager 220 may use the identifiers previously obtained to obtain the test code data structure 226 from the code provider 213. The test code data structure 226 may include code corresponding to the tests. In one embodiment, the test manager 220 may obtain the code for a test just before executing the code for the test. In another embodiment, the test manager 220 may obtain the code for all tests all at once or at some time after obtaining the identifiers. In yet another embodiment, the test manager 220 may obtain the code together with the identifiers. In other words, the code and the identifiers may come together from the primary test environment 205. In yet another embodiment, the tests may be obtained without identifiers and the actions of block 410 may be omitted. Obtaining the test code for a test may involve obtaining a copy of the test code, using a pointer to access the test code, or the like.

At block 420, a test is executed and throttling occurs as needed. For example, referring to FIG. 2, the test manager 220 may select a test and consult with the test throttler 221 as to whether the test may be executed. In another embodiment, the test manager 220 may select a test and queue the test for execution. The test throttler 221 may then allow the test to execute (e.g., configure a thread to execute the test) when doing so will not exceed a threshold. In this sense, the test throttler 221 may be said to restrict how many of the tests are allowed to execute in parallel in the auxiliary test environment 206.

In one embodiment, the test throttler 221 may restrict the number of threads allocated (e.g., available) to execute the tests. If the allocated threads are all executing tests, another thread may not be allocated until one of the threads has completed executing a test.

In another embodiment, the test throttler 221 may restrict a count of tests executing in parallel. If the number of tests equals or exceeds a threshold, waiting to start another test may occur until the number of executing tests falls below the threshold.

At block 425, results are obtained from the one or more tests. Results for a test may be obtained while the test executes and when the test completes (with success, failure, and/or throwing an exception). For example, referring to FIG. 2, the results manager 222 may obtain results from a test that executes in the auxiliary test environment 206. In one embodiment, results may be obtained for a test by performing actions including:

1. Calling initialization code of the test, if any;

2. Invoking (e.g., executing) the test in a try/catch block and obtaining any codes returned from try/catch block; and

3. Calling cleanup code of the test, if any.

The results may also be obtained by capturing log data generated by a test.

At block 430, results may be placed in a data structure that is accessible by a process of the primary test environment. The process may use the results to determine whether an indicated test has already been executed in the auxiliary test environment and, if so, what results were obtained therefrom.

The actions associated with blocks 415-430 may be repeated (and performed in parallel) until all tests have been executed. In one embodiment, the test manager of the auxiliary test environment may check to see whether the test is currently being executed in the primary test environment. If this is the case, the test manger of the auxiliary test environment may skip executing the test in the auxiliary test environment.

At block 435 other actions, if any, may be performed.

At block 440, status events may be generated. As described previously, status events may be generated so that an auxiliary watcher may be able to determine the status of tests that will execute, are executing, or have executed in the auxiliary test environment. A status event may be generated, for example, when a test is queued for execution, when a test starts execution, when a test completes execution, and the like. The actions of block 435 may occur at various times in conjunction with the actions indicated in the blocks 410-435.

Turning to FIG. 5, at block 505, the actions begin. At block 510, a collection of tests are configured to be executed in a primary test environment are sent to an auxiliary test environment. For example, referring to FIG. 2, the test provider 212 may send a collection of tests to the test manager 220 via the test list data structure 225.

At block 515, test code may be provided to the auxiliary test environment. For example, referring to FIG. 2, the code provider 213 may provide test code for one or more of the tests to the test manager 220. The test code may be provided in response to a request from the test manager 220, may be placed in the test code data structure 226 for on-demand use by the test manager 220, or may be delivered in another manner without departing from the spirit or scope of the subject matter described herein.

At block 520, a determination is made of a test to execute in the primary test environment. For example, referring to FIG. 2, the test manager 210 may select a test of a collection of tests that are configured to be executed in the primary test environment 205.

At block 525, a determination is made as to whether the test has already executed in the auxiliary test environment. For example, referring to FIG. 2, the test result detector 211 may determine (e.g., by checking a flag) whether the test has already executed in the auxiliary test environment 206

At block 530 if the test has already executed in the auxiliary test environment, the actions continue at block 540; otherwise, the actions continue at block 535.

At block 535, since the test has not already executed in the auxiliary test environment, various actions may occur. For example, if the test has not already executed in the auxiliary test environment, waiting for the test to execute in the auxiliary test environment may occur. After the test completes, results may then be obtained. For example, referring to FIG. 2, a component (e.g., the test result detector 211, the results manager 215, or another component) of the primary test environment 205 may wait for the test to be executed in the auxiliary test environment 206.

As another example, if the test has not already executed in the auxiliary test environment, the test may be executed in the primary test environment. For example, referring to FIG. 2, the test may be executed in the primary test environment 205. In this example, results, if any, obtained for the test by executing the test in the auxiliary test environment may be ignored.

At block 540, the test results may be obtained from a data structure populated by a process of the auxiliary test environment. For example, referring to FIG. 2, the results manager 215 may obtain the results from the return codes data structure 227 and the log data structure 228, and may incorporate the results into the primary test environment 205 using the techniques previously described.

The actions associated with blocks 520-540 may be repeated multiple times until results have been obtained for all the tests.

At block 545 other actions, if any, may be performed.

At block 550, an auxiliary watcher user interface may be updated. For example, referring to FIGS. 2 and 3, the auxiliary watcher 215 may periodically retrieve the events from the notifications data structure 229 and may post the events as a batch to the window 300.

As can be seen from the foregoing detailed description, aspects have been described related to test execution. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A method implemented at least in part by a computer, the method comprising:
obtaining tests configured to be executed in a test environment, the tests involving software code;
executing one or more of the tests in parallel with one or more of the tests executing within the test environment; and
placing results of executing the one or more tests in a data structure accessible by a process of the test environment to use at least to determine whether an indicated test has already been executed.

2. The method of claim 1, wherein obtaining test configured to be executed in a test environment comprises obtaining one or more identifiers associated with the tests and using one or more of the identifiers to obtain code corresponding to the one or more tests from the test environment.

3. The method of claim 1, further comprising restricting how many of the one or more tests are allowed to execute in parallel at any given time based on a threshold.

4. The method of claim 3, wherein restricting how many of the one or more tests are allowed to execute in parallel at any given time based on a threshold comprises waiting to execute another test until a number of tests executing in parallel falls below the threshold.

5. The method of claim 1, further comprising obtaining results of executing a test by performing actions, comprising:
calling initialization code of the test, if any;
invoking the test in a try/catch block and obtaining any codes returned from try/catch block; and
calling cleanup code of the test, if any.

6. The method of claim 1, further comprising obtaining the results by obtaining log data generated by executing the one or more tests in parallel.

7. The method of claim 1, further comprising generating events that indicate status of executing the one or more tests in parallel and placing the events in a data structure accessible by a process of the test environment.

8. The method of claim 1, further comprising determining whether a test is executing or has already executed in the test environment and if so refraining from executing the test outside of the test environment.

9. The method of claim 1, wherein executing one or more of the tests in parallel with one or more of the tests executing within the test environment comprises executing at least one instruction of at least one of the one or more of the tests after a first instruction and before a last instruction of a test executed within the test environment.

10. A computer storage medium having computer-executable instructions, which when executed perform actions, comprising:
sending, to an auxiliary test environment, a collection of tests that are configured to be executed in a primary test environment;
determining a test to execute in the primary test environment;
determining whether the test has already executed in the auxiliary test environment; and
if the test has already executed in the auxiliary test environment, obtaining results of the test from a data structure populated by a process of the auxiliary test environment, the process operable to populate the data structure based on data returned by executing the test in the auxiliary test environment.

11. The computer storage medium of claim 10, further comprising if the test has not already executed in the auxiliary test environment, waiting for the test to execute in the auxiliary test environment and thereafter obtaining the results from the data structure.

12. The computer storage medium of claim 10, further comprising if the test has not already executed in the auxiliary test environment, executing the test in the primary test environment and ignoring results, if any, obtained for the test by the executing the test in the auxiliary test environment.

13. The computer storage medium of claim 10, wherein sending a collection of tests that are to be executed in a primary test environment comprises writing a collection of identifiers of the tests to a file accessible via the auxiliary test environment.

14. The computer storage medium of claim 10, wherein sending a collection of tests that are to be executed in a primary test environment comprises writing a collection of identifiers of the tests to an in memory data structure accessible via the auxiliary test environment.

15. The computer storage medium of claim 10, wherein determining whether the test has already executed comprises reading a flag of the data structure, the flag indicating whether the test has already executed.

16. The computer storage medium of claim 10, further comprising if the test has already executed in the auxiliary test environment, returning the results via a process of the primary test environment by performing actions including one or more of:
throwing an exception within the process, the exception corresponding to an exception indicated by the data structure;
returning a return code to the process of the primary test environment, the return code corresponding to a return code indicated by the data structure; and
writing, via the process, an entry to a log file of the primary test environment, the entry corresponding to an entry indicated by the data structure.

17. The computer storage medium of claim 10, further comprising providing, to the auxiliary test environment, code corresponding to one or more of the tests.

18. In a computing environment, a system, comprising:
a primary test environment and an auxiliary test environment,
the primary test environment including:
a first test manager operable to execute tests involving software code in the primary test environment;
a test provider operable to provide an indication of the tests to the auxiliary test environment;
a code provider operable to provide code of the tests to the auxiliary test environment;
a test result detector operable to determine whether an indicated test has already executed in the auxiliary test environment; and
a results manager operable to obtain results of the indicated test from a data structure if the indicated test has already executed in the auxiliary test environment, the data structure accessible from both the primary test environment and the auxiliary test environment;
the auxiliary test environment including:
a second test manager operable to execute one or more of the tests in the auxiliary test environment in parallel with one or more of the tests executing in the primary test environment; and
a results manager operable to populate the data structure with results obtained by executing the one or more of the tests in the auxiliary test environment.

19. The system of claim 18, wherein the primary test environment comprises a process of a computer and wherein the auxiliary test environment comprises another process of the computer.

20. The system of claim 18, wherein the primary test environment comprises a first computer and wherein the auxiliary test environment comprises a second computer communicably coupled to the first computer.
